(19) United States
(12) Patent Application Publication
(10) Pub. No.: US 2015/0286688 A1
(43) Pub. Date: Oct. 8, 2015

(54) Apparatus and Method for Management of Bitemporal Objects

(71) Applicant: MarkLogic Corporation, San Carlos, CA (US)

(72) Inventors: Fei Xue, San Carlos, CA (US); Gajanan Chinchwadkar, Fremont, CA (US); Christopher Lindblad, Moraga, CA (US)

(73) Assignee: MarkLogic Corporation, San Carlos, CA (US)

(21) Appl. No.: 14/677,870

(22) Filed: Apr. 2, 2015

Related U.S. Application Data
(60) Provisional application No. 61/976,378, filed on Apr. 7, 2014.

(51) Int. Cl. G06F 17/30

(52) U.S. Cl. CPC G06F 17/30551; G06F 17/30572

(57) ABSTRACT

A machine has a processor and a memory connected to the processor. The memory stores instructions executed by the processor to construct an object collection where each object in the object collection has a common identifier, a valid time start field, a valid time end field, a system time start field and a system time end field. The object collection includes split objects with a legacy object and an updated object with the system time start field set to the system time that the split objects are formed.

### CROSS-REFERENCE TO RELATED APPLICATION

This application claims priority to U.S. Provisional Patent Application Ser. No. 61/976,378, filed Apr. 7, 2014, the contents of which are incorporated herein by reference.

### FIELD OF THE INVENTION

This invention relates generally to data processing in computer networks. More particularly, this invention relates to techniques for management of objects with valid time stamps and system time stamps (bitemporal objects).

### BACKGROUND OF THE INVENTION

Bitemporal objects are associated with both a valid time that marks when a thing is known in the real world and a system time that marks when the thing is available for discovery in a Server. Bitemporal data is necessary whenever there is a requirement to maintain snapshots of a transaction across various time dimensions. For example, financial and insurance industries use bitemporal data to track changes to contracts, policies, and events in a manner that adheres to strict regulation and compliance requirements.

There is a need for improved techniques for managing bitemporal objects.

### SUMMARY OF THE INVENTION

A machine has a processor and a memory connected to the processor. The memory stores instructions executed by the processor to construct an object collection where each object in the object collection has a common identifier, a valid time start field, a valid time end field, a system time start field and a system time end field. The object collection includes split objects with a legacy object and an updated object with the system time start field set to the system time that the split objects are formed.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates temporal collections constructed in accordance with an embodiment of the invention.

FIG. 4 illustrates an example of an object split in accordance with an embodiment of the invention.

FIG. 5 illustrates search results obtained utilizing a query processor configured in accordance with an embodiment of the invention.

FIG. 6 illustrates search results obtained utilizing a query processor configured in accordance with an embodiment of the invention.

FIG. 7 illustrates search results obtained utilizing a query processor configured in accordance with an embodiment of the invention.

FIG. 8 illustrates search results obtained utilizing a query processor configured in accordance with an embodiment of the invention.

FIG. 9 illustrates a temporal collection constructed in accordance with a disclosed example.

FIG. 10 illustrates Last Stable Query Time (LSQT) processing performed in accordance with an embodiment of the invention.

FIG. 11 illustrates document split operations performed in accordance with disclosed processing associated with an embodiment of the invention.

FIG. 12 illustrates document split operations performed in accordance with disclosed processing associated with an embodiment of the invention.

FIG. 13 illustrates document split operations performed in accordance with disclosed processing associated with an embodiment of the invention.

FIG. 14 illustrates a rollback operation performed in accordance with an embodiment of the invention.

FIG. 15 illustrates Allen operators utilized in accordance with an embodiment of the invention.

FIG. 16 illustrates multi-temporal object insertion supported in accordance with an embodiment of the invention.

Like reference numerals refer to corresponding parts throughout the several views of the drawings.

### DETAILED DESCRIPTION OF THE INVENTION

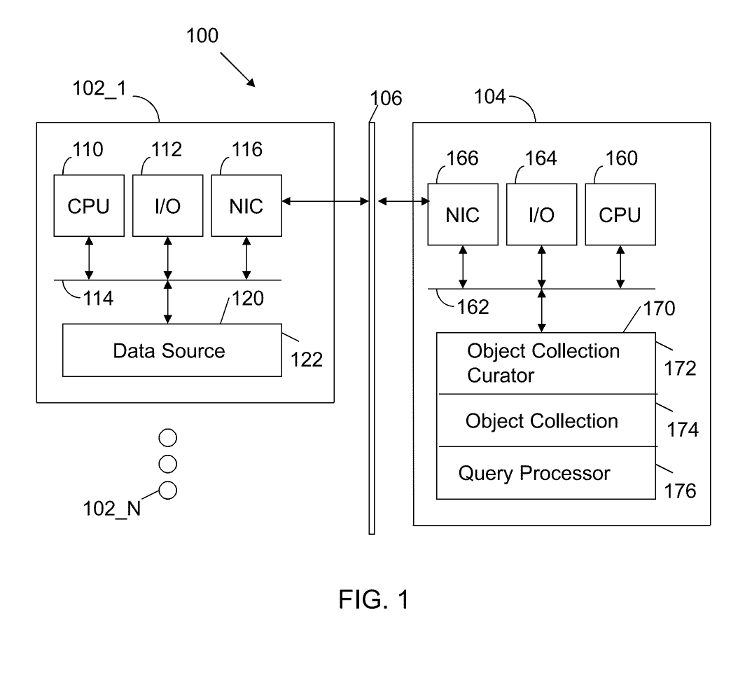

FIG. 1 illustrates a system 100 configured in accordance with an embodiment of the invention. The system 100 includes a set of client device 102_1 through 102_N connected to a server 104 via a network 106, which may be in any combination of wired and wireless networks.

Each client device 102 includes standard components, such as a central processing unit connected to input/output devices 112 via a bus 114. The input/output devices 112 may include a keyboard, mouse, touch display and the like. A network interface circuit 116 is also connected to the bus 114 to provide connectivity to network 106. A memory 120 is also connected to the bus 114. The memory 120 stores a data source 122 configured for uploading to server 104.

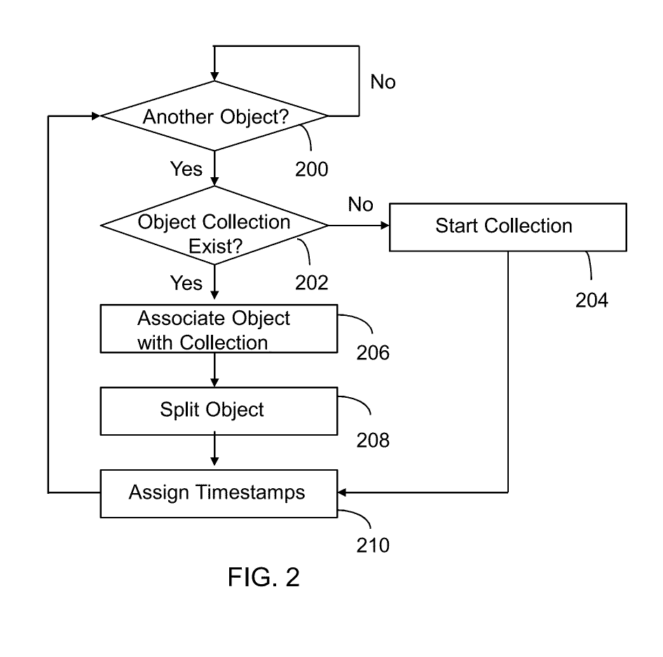

The server 104 also includes standard components, such as a central processing unit 160, a bus 162, input/output devices 164 and a network interface circuit 166. A memory 170 is connected to bus 162. The memory 170 stores instructions executed by the central processing unit 160 to implement operations of the invention. In one embodiment, the memory stores an object collection curator 172 with instructions to implement the operations shown in connection with FIG. 2. The object collection curator 172 constructs and curates an object collection 174, examples of which are provided below. A query processor 176 processes queries against the object collection 174. Exemplary query processor 176 operations are discussed below.

FIG. 2 illustrates processing operations associated with an embodiment of the invention. The object curator 172 tests whether an object is available 200. For example, the object may be received over network 106 from data source 122. If an object is available (200—Yes), it is determined whether an object collection exists for this type of object 202. Each object may be specified with a Uniform Resource Indicator (URI). If such an object does not exist (202—No), a collection of that object type is started 204. If such an object already exists (202—Yes), the object is associated with its corresponding collection 206. The object is then split 208. In particular, the object is split between a legacy object with a valid time end field value and an updated object with a valid time start field value that is a single minimal incremental time unit (e.g., 1 second) greater than the valid time end field value of the legacy object. The minimal incremental time unit value is contingent upon the time resolution offered by the system. As demonstrated below, this operation results in a system time that has two versions of an object, where each version of the object has different valid time values. The final operation of FIG. 2 is to assign timestamps. In particular, time stamp values are assigned to each version of the split object. The time stamps include a valid time start value, a valid time end value, a system time start value and a system time end value, examples of which are provided below.

The timestamp assignment operation 210 accommodates a user specified system start time. That is, the system allows one to set a system time start field to a value earlier than a current system time. Thus, an object inserted into a collection can effectively be placed backwards in system time. Most systems only allow objects to be inserted at or after system time. This feature is significant because client machines 102_1 through 102_N may be operating at slightly different time frames. An enterprise controlling the client machines may need to observe these distinct time domains.

If there is no user specified system start time, the current system time is used as the system start time. The system time end value is typically set to infinity upon object insertion. The system time end value may be set to system time or a user input value.

The foregoing is more fully appreciated with reference to various examples. Terms used in connection with the examples include:
Temporal refers to bitemporal objects, documents and collections.
Instant is an instant of time (such as, “12/31/2012, 01:00:00 am”).
Period is an anchored duration of time (e.g., Dec. 1, 1999 through Dec. 31, 2000, the fall semester).
Axis is a named pair of range indexes that is a container for periods.

Temporal objects have both a valid axis and system axis.
User-defined Time is a time value that a user provides in replacement of system start time.
Last Stable Query Time (LSQT) is an object with a system start time before this point can be queried and an object with a system start time after this point can be updated and ingested.
A split refers to the creation of a new object that corresponds to a previous object, but has different valid timestamps and a different system end time.
Valid Time is when the information was true in the real world. Valid time may also be called application time. Valid time is provided by the user or application (e.g., data source 122 of client 102). The valid end time is updated by the system when an object is split.
System Time is when the information was stored in the object collection 174. System time may also be called transaction time. System time is managed by the server 104, except in cases when the system start time is set by the application as discussed below.

A bitemporal object is managed as a series of versioned objects in a collection. The ‘original’ object inserted into the object collection is kept and never changes. Updates to the object are inserted as new objects with different valid and system times. A delete of the object is also inserted as a new object. In this way, a bitemporal object can be “rolled back” to review, at any point in time, when the information was known in the real world and when it was recorded in the object collection.

Bitemporality is defined on a collection, sometimes referred to as a temporal collection. A temporal collection is a logical grouping of temporal objects that share the same axes with timestamps defined by the same range indices. One can create additional temporal collections for objects that require a different schema for the timestamps. An object can be in any number of forms, including a Resource Description Framework (RDF) object, an eXtensible Markup Language (XML) object, a JavaScript Object Notation (JSON) object and a text object. Objects are sometimes referred to herein as documents.

When a document is inserted into a temporal collection, a URI collection is created for that document. When the document is updated, a new document representing the update is inserted into the document's URI collection. Any new document inserted into the temporal collection has its own unique URI collection that holds all of the versions of that document. The latest version of each document resides in a latest collection.

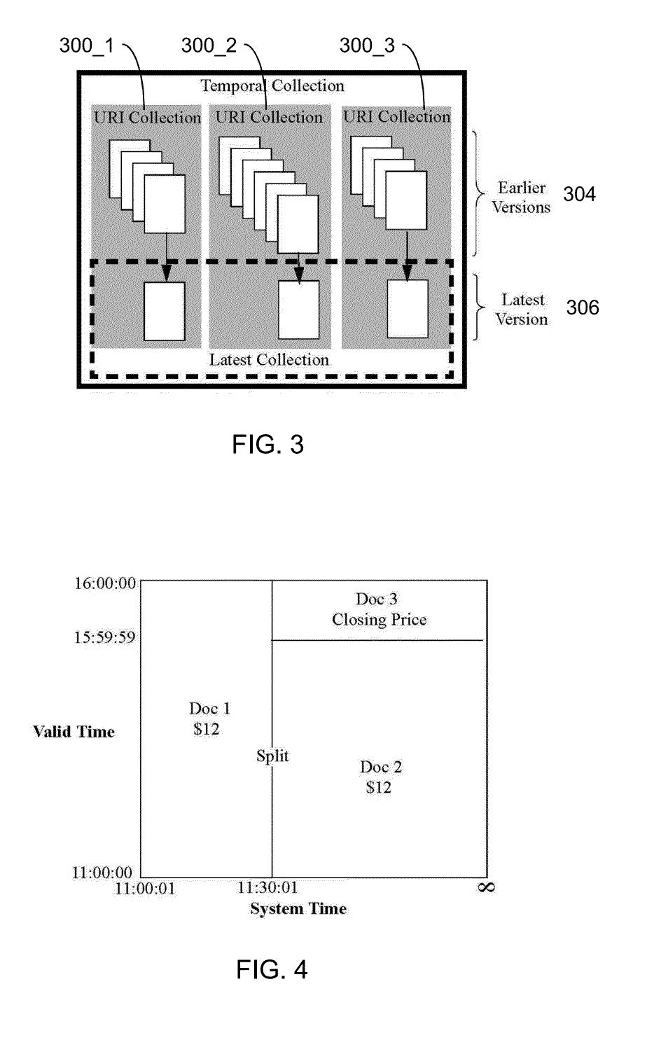

FIG. 3 illustrates this schema. In particular, the figure illustrates different collections 300_1, 300_2, 300_3. Each document in each collection has the same URI. Objects may be segregated by earlier versions 304 and latest version 306.

The valid and system axis each make use of dateTime range indexes that define the start and end times. For example, the following code creates element range indexes to be used to create the valid and system axes. The follow code is in JavaScript®. XQuery® or other languages may also be used in accordance with embodiments of the invention.

```
var admin = require(“/MarkLogic/admin.xqy”);
var config = admin.getConfiguration( );
var dbid = xdmp.database(“Documents”);
var validStart = admin.databaseRangeElementIndex(
  “dateTime”, “”, “validStart”, “”, fn.false( ) );
var validEnd = admin.databaseRangeElementIndex(
  “dateTime”, “”, “validEnd”, “”, fn.false( ) );
var systemStart = admin.databaseRangeElementIndex(
  “dateTime”, “”, “systemStart”, “”, fn.false( ) );
var systemEnd = admin.databaseRangeElementIndex(
  “dateTime”, “”, “systemEnd”, “”, fn.false( ) );
config = admin.databaseAddRangeElementIndex(config, dbid,
validStart);
config = admin.databaseAddRangeElementIndex(config, dbid, validEnd);
config = admin.databaseAddRangeElementIndex(config,
  dbid,systemStart);
config = admin.databaseAddRangeElementIndex(config, dbid, systemEnd);
admin.saveConfiguration(config);
```

System and valid axes may be formed using the following JavaScript® code.

```
var temporal = require(“/MarkLogic/temporal.xqy”);
var validResult = temporal.axisCreate( “valid”,
  cts.elementReference(fn.QName(“”, “validStart”)),
  cts.elementReference(fn.QName(“”, “validEnd”)));
var systemResult = temporal.axisCreate( “system”,
  cts.elementReference(fn.QName(“”, “systemStart”)),
  cts.elementReference(fn.QName(“”, “systemEnd”)));
```

An object collection or temporal collection named “kool” may be created using the previously created system and valid axes. The following code accomplishes this.

var temporal = require(“/MarkLogic/temporal.xqy”);
var collectionResult =
temporal.collectionCreate( “kool”, “system”,
“valid”);

Consider the example of a stock trader, John, who places an order to buy some stock. The record of the trade is stored as a bitemporal object. The stock of KoolCo is trading around $12.65. John places a limit order to buy 100 shares of the stock for $12 at 11:00:00 on 3 Apr. 2014 (this is the valid time). The document for the transaction is recorded in the broker's database at 11:00:01 on 3 Apr. 2014 (this is the system time).

```
var temporal = require(“/MarkLogic/temporal.xqy”);
var root =
  { “tempdoc”: {
    “systemStart”:
    null,
    “systemEnd”:
    null,
    “validStart”: “2014-04-
    03T11:00:00”, “validEnd”:
    “2014-04-03716:00:00”,
    “trader”: “John”,
    “price”: 12
    }
  }
  ;
declareUpdate( );
temporal.documentInsert(“kool”, “koolorder.json”, root);
```

The last line of code inserts the document. The temporal collection is “kool”, the URI is “koolorder.json” and the root is the content of the document.

John looks at the trading pattern of the stock over the last week and notices that it always dips during the last minute of the trading day. At 11:30:00, John changes his order to buy the stock at the closing price (15:59:59). The change is recorded as another document in the broker's database at 11:30:01.

```
var temporal = require(“/MarkLogic/temporal.xqy”);
var root =
  { “tempdoc”: {
    “systemStart”:
    null,
    “systemEnd”:
    null,
    “validStart”: “2014-04-
    03T15:59:59”, “validEnd”:
    “2014-04-03715:59:59”,
    “trader”: “John”,
    “price”: Closing Price
    }
  };
declareUpdate( );
temporal.documentInsert(“kool”, “koolorder.json”, root);
```

This results in three documents with valid and system times as shown in FIG. 4. Note that the action resulted in a split on Doc 1 that resulted in Doc 2, as well as Doc 3 that contains the new content.

The object collection may now be queried. The following query searches the temporal documents, using the cts:period-range-query function to locate the documents that were in the database between 11:10 and 11:15.

```
cts.search(cts.periodRangeQ
  uery( “system”,
  “ISO_CONTAI
  NS”,
  cts.period(xs.dateTime(“2014-04-
    03T11:10:00”), xs.dateTime(“2014-
    04-03T11:15:00”)) ));
```

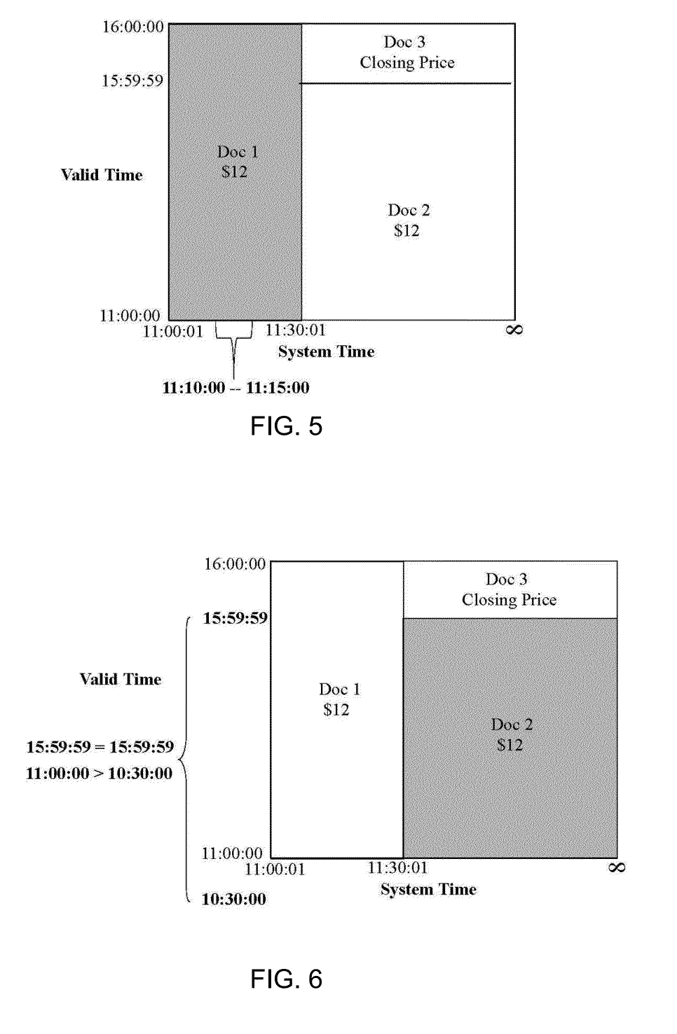

In this example, only Doc 1 meets the search criteria. This is shown pictorially in FIG. 5.

The following query searches the temporal documents, using the cts:period-range-query function to locate the documents that have a valid time period that starts after 10:30 and ends at 15:59. ALN_FINISHES is one of the comparison operators described in “Allen Operators” discussed in detail below.

```
cts.search(cts.periodRangeQ
  uery( “valid”,
  “ALN_FINISH
  ES”,
  cts.period(xs.dateTime(“2014-04-
    03T10:30:00”), xs.dateTime(“2014-
    04-03T15:59:59”)) ));
```

In this example, only Doc 2 meets the search criteria, as shown in FIG. 6.

The following query searches the temporal documents, using the cts:period-range-query function to locate the documents that were in the database after 11:20.

ALN_AFTER is one of the comparison operators described below in connection with “Allen Operators”.

```
cts.search(cts.periodRangeQ
  uery( “system”,
  “ALN_AFTER”,
  cts.period(xs.dateTime(“2014-04-
    03T11:00:00”), xs.dateTime(“2014-
    04-03T11:20:00”)) ));
```

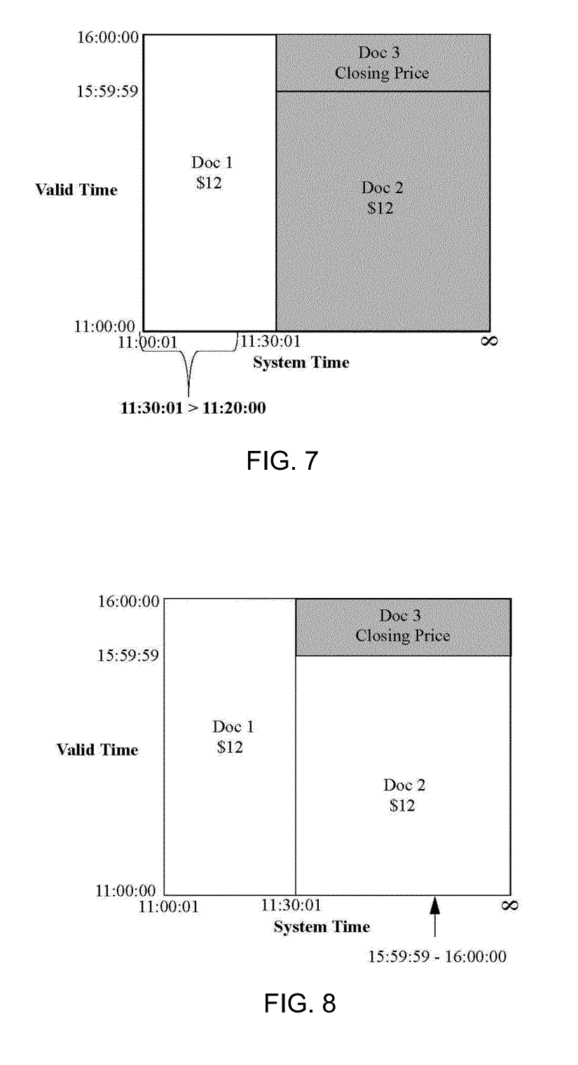

In this example, both Doc 2 and Doc 3 meet the search criteria, as shown in FIG. 7.

The following query searches the temporal documents, using the cts:period-compare-query function to locate the documents that were in the database when the valid time period is within the system time period. ISO_CONTAINS is one of the comparison operators described below in connection with “ISO SQL 2011 Operators”.

```
cts.search(cts.periodCompareQ
  uery( “system”,
  “ISO_CONTA
  INS”,
  “valid”
  ))
```

In this example, only Doc 3 meets the search criteria, as shown in FIG. 8.

The following query uses the cts:and-query to AND two cts:collection-query functions to return the temporal document that is in the URI collection, koolorder.xml, and the latest collection.

```
cts.search(cts.andQuery([
  cts.collectionQuery(“koolorder.js
  on”),
  cts.collectionQuery(“latest”)]))
```

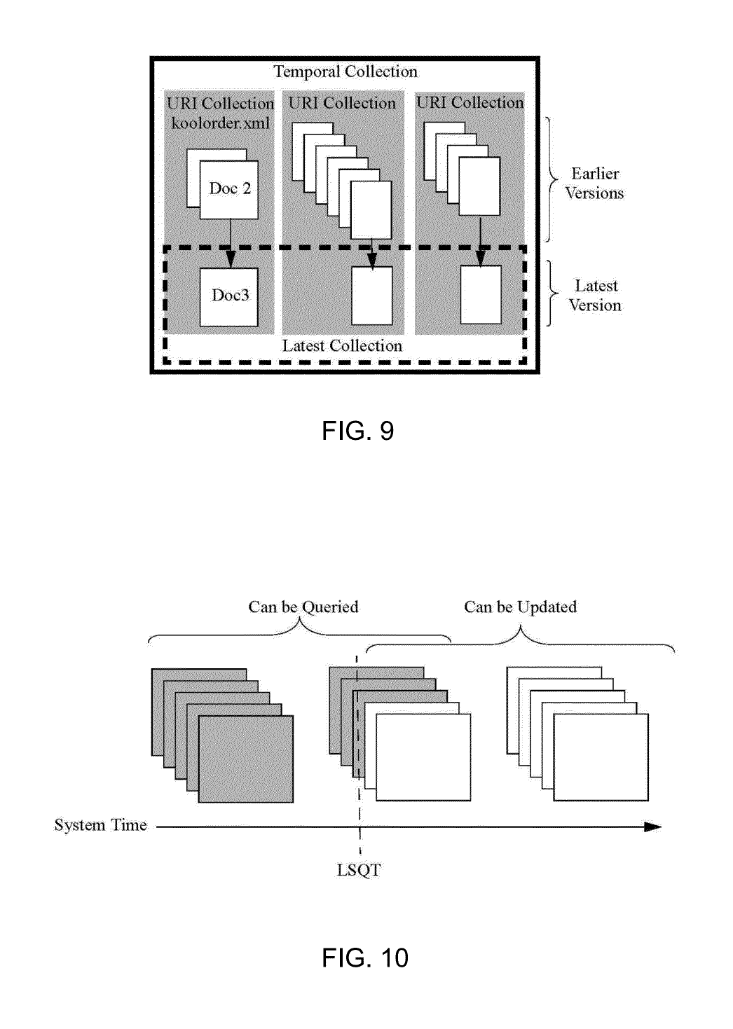

In this example, Doc 3 meets the search criteria, as shown in FIG. 9.

The system is configured to allow one to manually set the system start time when inserting or updating a document in a collection. This feature is useful when one needs to maintain a “master” system time across multiple clients that are concurrently inserting and updating bitemporal documents, without the need for the clients to communicate with one another in order to coordinate their system times.

The system start times for document versions with the same URI must progress along the system time axis, so that an update to a document cannot have a system start time that is earlier than that of the document that chronicles its last update. However, when managing documents with different URIs in a temporal collection, it is necessary to ensure that the system time progresses at the same rate for every document insert and update.

A special timestamp, called the Last Stable Query Time (LSQT) can be enabled on a temporal collection to manage system start times across documents with different URIs. A temporal document with a system start time before the LSQT can only be queried and a document with a system start time after the LSQT can be updated/ingested, but not queried. This approach is illustrated in FIG. 10. One can advance the LSQT either manually or automatically. This allows one to manage which documents are available to be queried and which documents can be updated.

When LSQT is enabled on a temporal collection, the LSQT value starts at 0 (lowest timestamp). When advanced, document reads and writes are queued until the LSQT is reset to the maximum system start time in the database. For example, the following query first checks to make sure the application time (simulated by the current time) is greater than the LSQT:

```
xquery version “1.0-ml”;
import module namespace temporal =
  “http://marklogic.com/xdmp/temporal” at
  “/MarkLogic/temporal.xqy”;
let $appTime : = fn:current-dateTime( )
let $LSQT : = temporal:get-LSQT(“temporalcollection”)
let $root : =
<tempdoc>
  <systemStart/>
  <systemEnd/>
  <validStart>2014-06-03T14:13:05</validStart>
  <validEnd>9999-12-31T23:59:59.99Z</validEnd>
  <content>v1-content here</content>
</tempdoc>
let $systemTime : =
    if ($appTime > $LSQT)
    then (temporal:statement-set-system-
    time(xs:dateTime($appTime)))
    el
    se
    ( )
return
  temporal:document-
    insert(
    “temporalcollectio
    n”, “doc.xml”,
    $ro
    ot)
    ,
  $systemT
  ime )
```

One can use the temporal:document-delete function to delete temporal documents. Deleting a temporal document maintains the document and all of its versions in the URI collection and updates the deleted document and all of its versions that have a system end time of infinity to the time of the delete. Deleting a temporal document removes the document from the latest collection. So the latest collection is the source of all of the documents that are currently valid and the URI collections are the source of the history of each document. Should one insert a document using the same URI as a deleted document, the deleted document, and all of its previous versions remain in the same URI collection as the “newly” inserted document. The newly inserted document is then added to the latest collection.

Returning to the example discussed in connection with FIG. 4, at 12:10:00, John changes his mind again and decides to change his order to a limit order to buy at $12.50. The following code reflects this change.

```
var temporal = require(“/MarkLogic/temporal.xqy”);
var root =
  { “tempdoc”: {
    “systemStart”:
    null,
    “systemEnd”:
    null,
    “validStart”: “2014-04-
    03T12:10:00”, “validEnd”:
    “2014-04-03716:00:00”,
    “content”: “12.50”
    }
  }
  ;
declareUpdate( );
temporal.documentInsert(“kool”, “koolorder.json”, root);
```

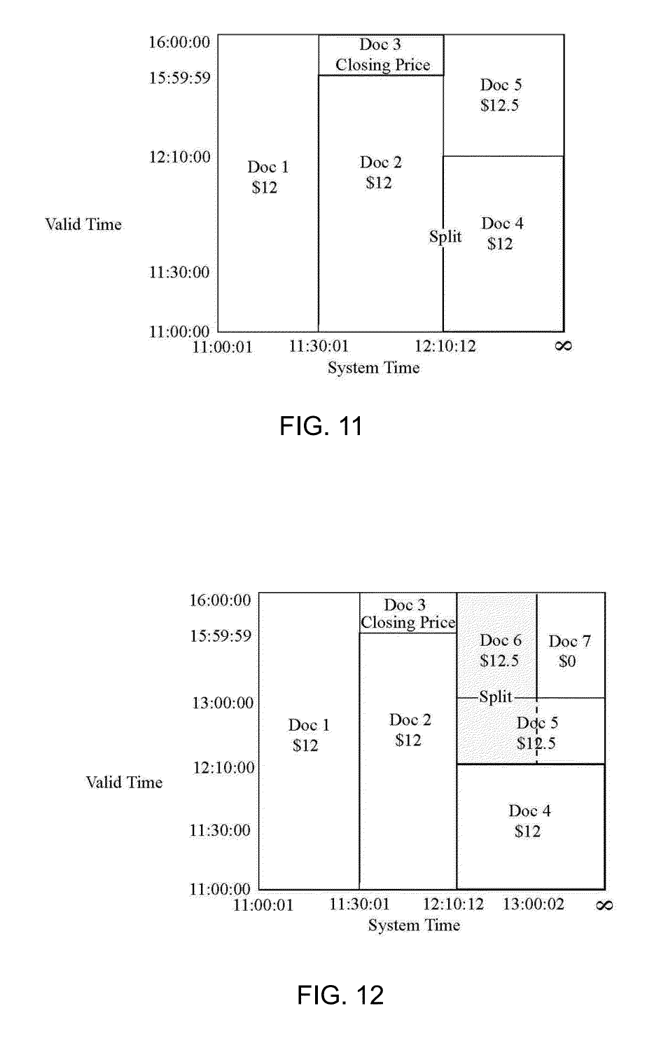

This transaction is recorded as another document with a valid time of 12:10:00, but due to heavy trading, the change is not recorded in the broker's database until 12:10:12. The resulting collection is shown in FIG. 11. Doc 3 is not split because the new Doc 5 contains the same period as Doc 3.

At 13:00:00, the purchase order has not been filled and John decides he no longer wants to buy the stock, so he cancels his order. This cancellation is recorded as another document with a valid time of 13:00:00 and recorded in the broker's database at 13:00:02. The following code reflects this activity.

```
var temporal = require(“/MarkLogic/temporal.xqy”);
var root =
  { “tempdoc”: {
    “systemStart”:
    null,
    “systemEnd”:
    null,
    “validStart”: “2014-04-
    03T13:00:00”, “validEnd”:
    “2014-04-03716:00:00”,
    “content”: “0”
    }
  }
  ;
declareUpdate( );
temporal.documentInsert(“kool”, “koolorder.json”, root);
```

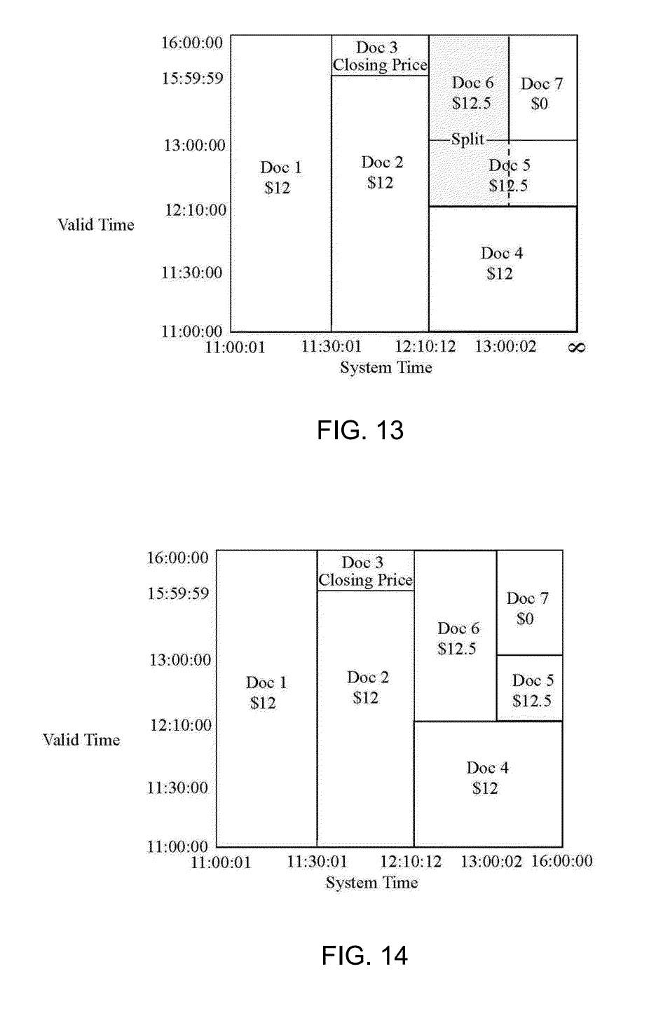

The resulting collection is shown in FIG. 12. At 13:00:01, the stock hits $12.50 and John's order is filled, which results in the collection in FIG. 13.

The broker's policy is to honor the valid times for all orders. At 13:00:03, the order fulfillment application reviews the valid and system times recorded in the cancellation document, determines that John in fact cancelled his order before it was filled, and does not debit his account for the stock purchase. At 16:00:00, the broker deletes the order, which results in the collection shown in FIG. 14.

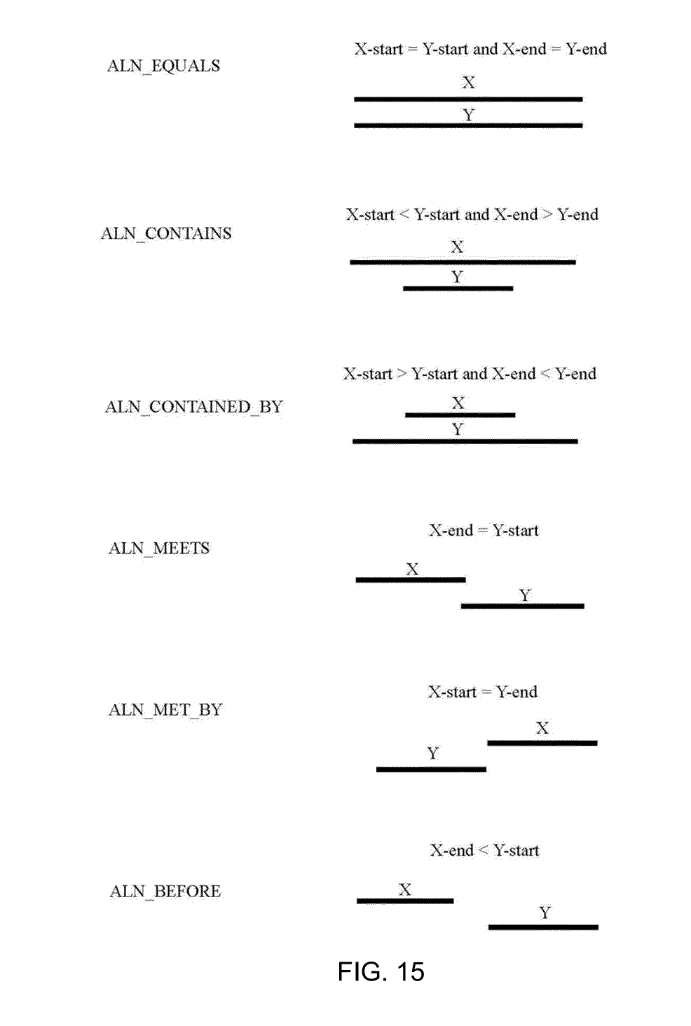

The query processor 176 may be configured to support Allen interval algebra operators. Allen interval algebra is a calculus for temporal reasoning. The calculus defines possible relations between time intervals and provides a composition table that can be used as a basis for reasoning about temporal descriptions of events. The left side of FIG. 15 illustrates Allen operators. To the right of each Allen operator are the corresponding time intervals. SQL provides similar operators that may be used in accordance with embodiments of the invention.

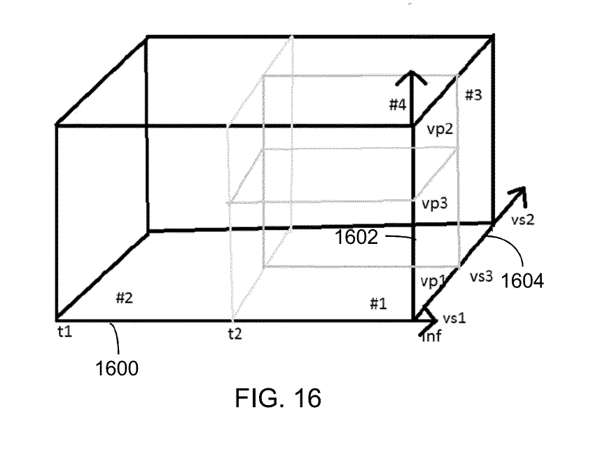

The foregoing examples reference two-dimensional object splitting. The disclosed system also supports multi-dimensional object splitting. Consider the multi-temporal time frame illustrated in FIG. 16. There is a system time axis 1600, a vp axis 1602 and a vs axis 1604. At time t1 content V1 is inserted between axis positions (vp1, vp2) and (vs1, vs2). This results in a three dimensional object occupying all of the disclosed space in FIG. 16. This can be expressed as (vp1, vp2), (vs1, vs2) and (t1, INF).

Next, there is an update at t2 with content V2. Vps3 is between vp1 and vp2, while vs3 is between vs1 and vs2. This update results in four cubes after the object split. Object “#1” has content V2 and is specified by (vp1, vp3), (vs1, vs3), (t2, INF). Object “#2” has content V1 and is specified by (vp1, vp2), (vs1, vs2), (t1, t2). Object “#3” has content V1 and is specified by (vp1, vp2), (vs2, vs3), (t2, INF). Finally object “#4” has content V1 and is specified by (vp3, vp2), (vs1, vs2), (t2, INF).

Those skilled in the art will appreciate that the disclosed techniques facilitate a number of computer system enhancements. Specified time ranges may be used to migrate selected objects to tiered storage. For example, older objects may be migrated to cheaper, slower storage resources (e.g., magnetic tape).

The query processor 176 may be configured to cache query results in system time segments to support range queries on system time. In this way, query results can be cached and utilized without being evicted from the cache.

The object collection curator 172 may be configured to form a replicated object from an object in the object collection 174. For example, a replica may be from a segment of a master object.

In one embodiment, the object collection curator 172 includes a safety switch that precludes the alteration of the history of an object. For example, the object collection curator 172 may be configured to disable edits to time field values.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising:
a processor; and
a memory connected to the processor, the memory storing instructions executed by the processor to:
construct an object collection wherein each object in the object collection has a common identifier, a valid time start field, a valid time end field, a system time start field and a system time end field;
wherein the object collection includes split objects with
a legacy object, and
an updated object with the system time start field set to the system time that the split objects are formed.

2. The machine of claim 1 wherein the split objects further comprise an additional updated object with the common identifier, a valid time start field, a valid time end field, a system time start field, a system time end field, a start axis field value and an end axis field value characterizing a multi-temporal object.

3. The machine of claim 1 wherein the memory stores instructions executed by the processor to establish a last stable query time value on a system time axis.

4. The machine of claim 3 wherein the memory stores instructions executed by the processor to query objects with system time end field values less than the last stable query time value.

5. The machine of claim 3 wherein the memory stores instructions executed by the processor to update objects with a system time start field value greater than the last stable query time value.

6. The machine of claim 1 wherein the memory stores instructions executed by the processor to migrate selected objects of the object collection to tiered storage in accordance with a specified time range.

7. The machine of claim 1 wherein the memory stores instructions executed by the processor to cache query results in system time segments to support range queries on system time.

8. The machine of claim 1 wherein the memory stores instructions executed by the processor to form a replicated object from an object within the object collection.

9. The machine of claim 1 wherein the memory stores instructions executed by the processor to disable edits to time field values.

10. The machine of claim 1 wherein the object collection designates early version object instances and a last object instance.

11. The machine of claim 1 wherein the memory stores instructions executed by the processor to apply Allen operators to the object collection.

12. The machine of claim 1 wherein the memory stores instructions executed by the processor to apply Structured Query Language operators to the object collection.

13. The machine of claim 1 wherein each object is selected from a Resource Description Framework (RDF) object, an eXtensible Markup Language (XML) object, a JavaScript Object Notation (JSON) object and a text object.

14. The machine of claim 1 wherein the memory stores instructions executed by the processor to set a system time start field to a value earlier than a current system time.
